(19) United States
(12) Patent Application Publication
(10) Pub. No.: US 2014/0244625 A1
(43) Pub. Date: Aug. 28, 2014

(54) SEQUENCE READ ARCHIVE INTERFACE

(71) Applicants: Brigitte G. Seghezzi, Mountain View, CA (US); Evan M. Worley, Palo Alto, CA (US); Bing Xia, Albany, CA (US)

(72) Inventors: Brigitte G. Seghezzi, Mountain View, CA (US); Evan M. Worley, Palo Alto, CA (US); Bing Xia, Albany, CA (US)

(73) Assignee: DNANEXUS, Inc., Mountain View, CA (US)

(21) Appl. No.: 14/238,469

(22) PCT Filed: Aug. 10, 2012
(86) PCT No.: PCT/US2012/050464

§ 371 Date: May 15, 2014

Related U.S. Application Data
(60) Provisional application No. 61/523,197, filed on Aug. 12, 2011.

(51) Int. Cl. G06F 17/30

(52) U.S. Cl. CPC G06F 17/30554
USPC 707/722

(57) ABSTRACT

A repository of DNA sequence data is available online. A user can query the repository using a search term. Search results that are provided by the repository include information about studies, experiments, samples, and/or runs that are related to the search term. A user can select one or more of the displayed search results. Based on the user selection, the repository provides relationship(s) between the selected results and run(s). Runs may be associated with DNA sequence data. The determined relationship between the search term and any available DNA sequence data is displayed. The DNA sequence data may be obtained by the user using, for example, the FASTQ format and/or the SRA format.

### CROSS-REFERENCE TO RELATED APPLICATIONS

This application claims priority benefit of U.S. Provisional Patent Application No. 61/523,197, filed Aug. 12, 2011. The entire contents of that application are hereby incorporated by reference herein.

### BACKGROUND

The Sequence Read Archive refers to a conventional repository of short and long sequence reads that are generated by second generation sequencing technologies. The Sequence Read Archive is accessible via the Internet and allows researchers to store and/or retrieve short and long sequence reads through a front-end search and browse tool. The Sequence Read Archive also allows researchers to download short and long sequence reads.

Sequence data such as short and long sequence reads are generally associated with a hierarchy of studies, experiments, samples, and runs. Specifically, a study may be associated with one or more experiments. An experiment, in turn, may be associated with one or more samples. Further, a sample may be associated with one or more runs. Finally, a run may be associated with sequence data.

Although sequence data are generally related to objects such as studies, experiments, samples, and runs as described above, the conventional Sequence Read Archive stores short and long sequence reads as mostly raw sequence data and assembly information. As a result, the conventional Sequence Read Archive does not allow a user to browse and identify relevant objects in a user-friendly manner. The conventional Sequence Read Archive also does not present the relationship of a set of sequence data with respect to the studies, experiments, samples, and/or runs that annotate the set of sequence data. Further, the conventional Sequence Read Archive does not provide a user with published reference information in a convenient manner.

### SUMMARY

In one embodiment, a search term and a search category are received, and are used to identify search results for display. Search results may include studies, experiments, samples, and/or runs. A user may select one or more of the displayed search results. A relationship between the selected results and one or more runs is determined. Runs may be associated with sequence data. At least a portion of the determined relationship may be displayed.

In one embodiment, a user's selection of filter controls may be received, and a subset of the search results may be removed from display in response to the selection of filter controls. In addition, a numerical count of the subset of search results that are to remain displayed may be shown prior to the display of the subset of the filtered search results. In one embodiment, sequence data associated with one or more runs may be transmitted to a user terminal. The sequence data may be transmitted in SRA and/or FASTQ format. In one embodiment, URLs to sequence data in the SRA and/or FASTQ formats may be transmitted. In one embodiment, published reference information, such as links to scientific publications and/or submission IDs may be displayed in the search results.

### DESCRIPTION OF THE FIGURES

FIG. 1 is a block diagram depicting an exemplary Sequence Read Archive Interface (SRA) system.

FIG. 2 is a screen view depicting an exemplary interface for searching the SRA system.

FIG. 3 is a screen view depicting an exemplary interface for searching and/or viewing SRA information.

FIG. 4 is a screen view depicting an exemplary interface for searching and/or viewing SRA information.

FIG. 5 is a screen view depicting an exemplary interface for viewing SRA information.

FIG. 6 is a screen view depicting an exemplary interface for viewing SRA information.

FIG. 7 is a screen view depicting an exemplary interface for viewing SRA information.

FIG. 8 is a screen view depicting an exemplary interface for viewing SRA information.

FIG. 9 is a screen view depicting an exemplary interface for searching and/or viewing SRA information.

FIG. 10 is a screen view depicting an exemplary interface for searching and/or viewing SRA information.

FIG. 11 is a screen view depicting an exemplary interface for filtering SRA information.

FIG. 12 is a screen view depicting an exemplary interface for filtering SRA information.

FIG. 13 is a screen view depicting an exemplary interface for filtering SRA information.

FIG. 14 is a screen view depicting an exemplary interface for selecting SRA information for download.

FIGS. 15A-15B are screen views depicting an exemplary interface for selecting SRA information for download.

FIG. 16 is a screen view depicting an exemplary interface for downloading SRA information.

FIG. 17 is a block diagram depicting an exemplary SRA system.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

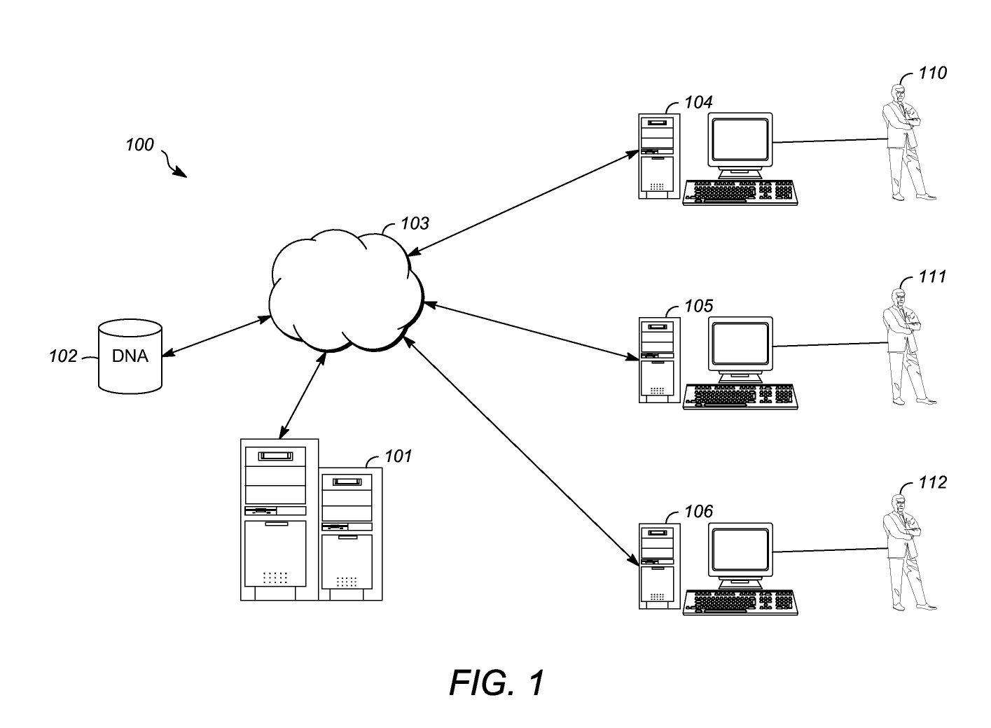

FIG. 1 depicts an exemplary Sequence Read Archive Interface (SRA) system 100. SRA system 100 may include server 101 and data storage 102 connected over network 103. Network 103 may be a local area network, wide area network, the Internet, or a combination thereof. Data storage 102 may be a SRA database containing sequence data such as DNA short codes, experimental data, and/or related information. Data storage 102 may include local, networked, and/or cloud storage devices and/or services. Server 101 may transmit sequence data to and from data storage 102 and may present sequence data to users 110-112 via terminals 104-106.

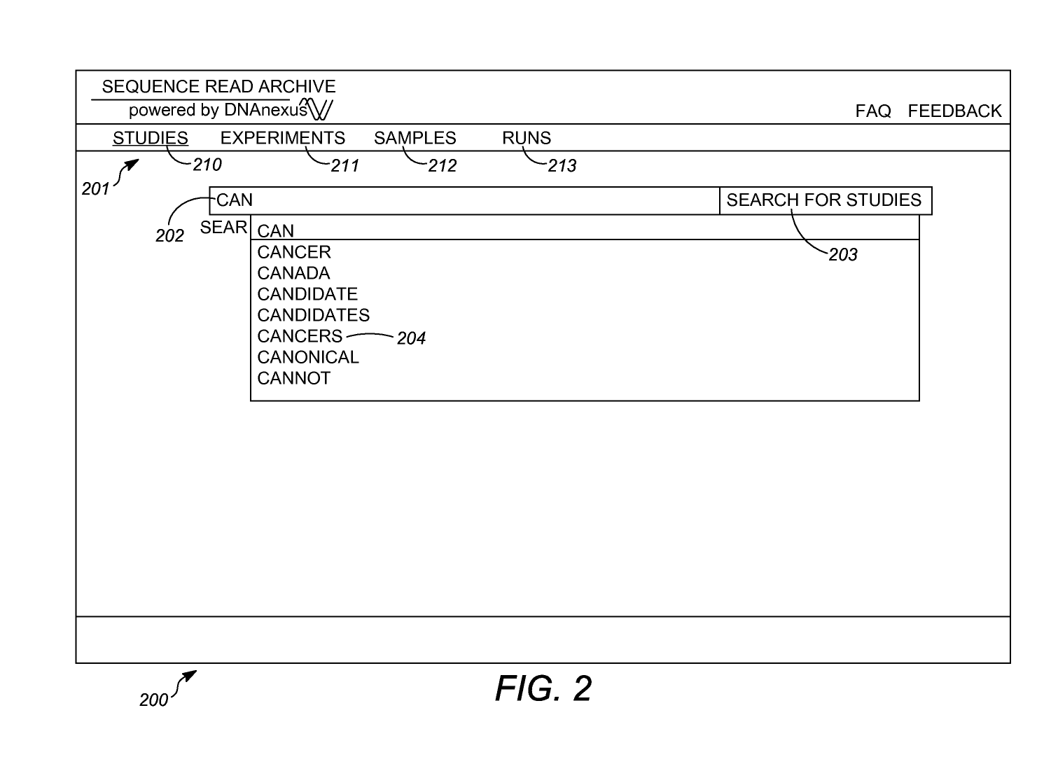

FIG. 2 depicts an exemplary search screen 200 for searching SRA data within a SRA database that is accessible to SRA system 100. Search screen 200 may include header 201, search box 202, search button 203, and auto-complete dialog 204. A user may enter a search term or a partial search term (e.g., “cancer” or “can”) into search box 202. In response to the user's entry, auto-complete dialog 204 may provide a list of suggested search terms. When multiple search terms are entered into search box 202, auto-complete dialog 204 may suggest search terms for each partial search term, in turn. For example, after a first term has been entered into search box 202, auto-complete dialog 204 may suggest a search term for the second term as the second term is being entered into search box 202.

The user may execute a search based on the search term(s) in search box 202 by clicking search button 203. As shown in FIG. 2, the search term “can” is entered into search box 202 and tab 210 representing studies is selected. Tab 210 may be selected by default by SRA system 100 when a user accesses SRA system 100 initially. Search button 203 may have a specific color that denotes the particular object (e.g., studies) to be searched via search button 203. Search button for other objects (e.g., experiments, samples, and/or runs) may each have a different color. When the user clicks on search button 203, SRA system 100 may search the SRA database for studies associated with the entered search term “can.”

In addition to studies, a user may search the SRA database for other objects, such as experiments, samples, and/or runs, by clicking on the corresponding tabs before clicking search button 203. Tabs 211, 212, and 213 are displayed on header bar 201 and correspond to experiments, samples, and runs, respectively. A user may also not enter any search term and execute the search (empty search) by clicking the search button 203, which will result in all objects to be returned. The same behavior can be observed when clicking any of the object tabs 210-213.

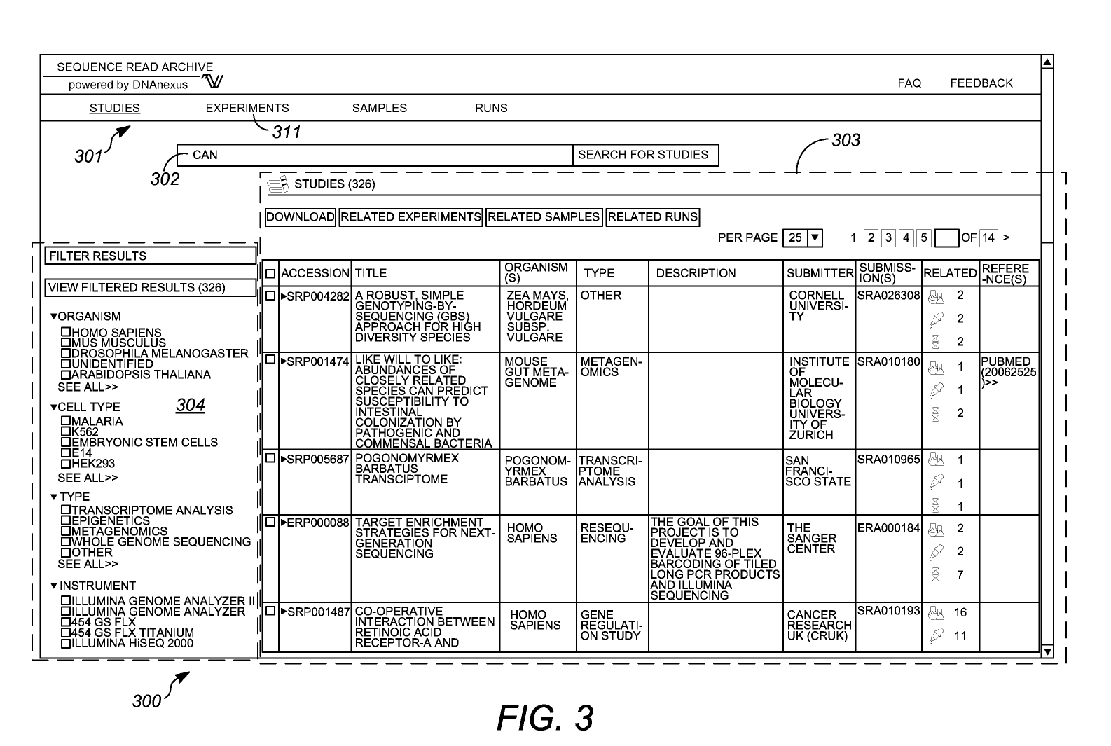

FIG. 3 depicts an exemplary search results screen 300 that SRA system 100 may present to a user after the user executes a search via search screen 200 (FIG. 2). Search results screen 300 may display studies based on matches between studies from the SRA database and the search term entered on search screen 200 (e.g., “can”). More specifically, SRA system 100 may display a study in search results screen 300 if the entered search term (e.g., “can”) appears in one or more of the following categories of information associated with the study: annotations, properties, accession IDs, organism name, synonyms, and/or relationships with common genbank and/or scientific names. These categories of information may be referred to as being searchable. In some embodiments, the searchability of a category of information may be configured by a user or a system administrator, and as such, searches may be performed against other categories of information.

Search results screen 300 may include header 301, search box 302, search results table 303, and filter dialog 304. Search box 302 may display the entered search term from search box 202 (FIG. 2). Search results table 303 may include information about studies that are associated with the entered search term from search box 202 (FIG. 2). Filter dialog 304 includes filter controls that may prevent the display of certain objects in search results table 303. As shown in FIG. 3, search result table 303 includes information related to a total of 326 studies that are associated with the search term “can,” and displays a subset of the search results (e.g., 25 studies) at a time.

A user may perform a search for other objects (e.g., experiments, samples, or runs) based on the existing search term as shown in search box 302 by clicking on the object tabs of header 301. For example, a user may click object tab 311, which represents experiment objects. In response, SRA system 100 may search for experiments matching the entered search term (e.g., “can”).

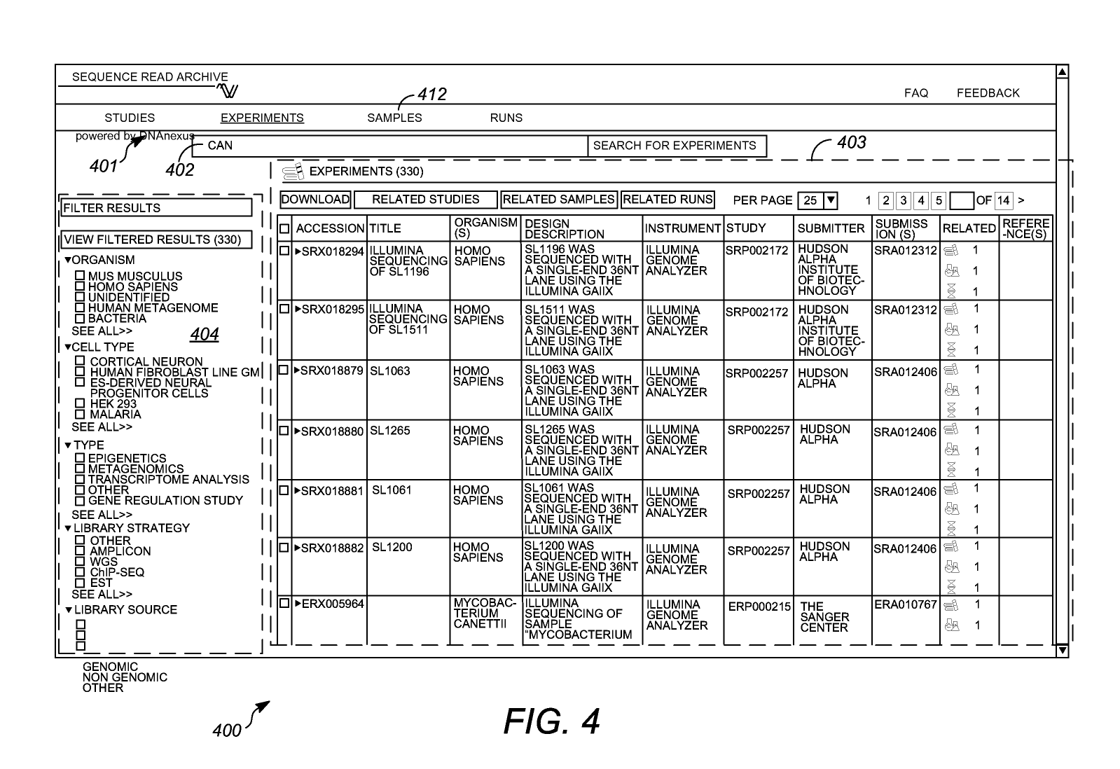

FIG. 4 depicts an exemplary search results screen 400 that SRA system 100 may present to the user after the user clicks on tab 311 from search results screen 300 (FIG. 3). Search results screen 400 may include header 401, search box 402, search results table 403, and filter dialog 404. Search results table 403 may include information related to a total of 330 experiments that match the search term “can.”

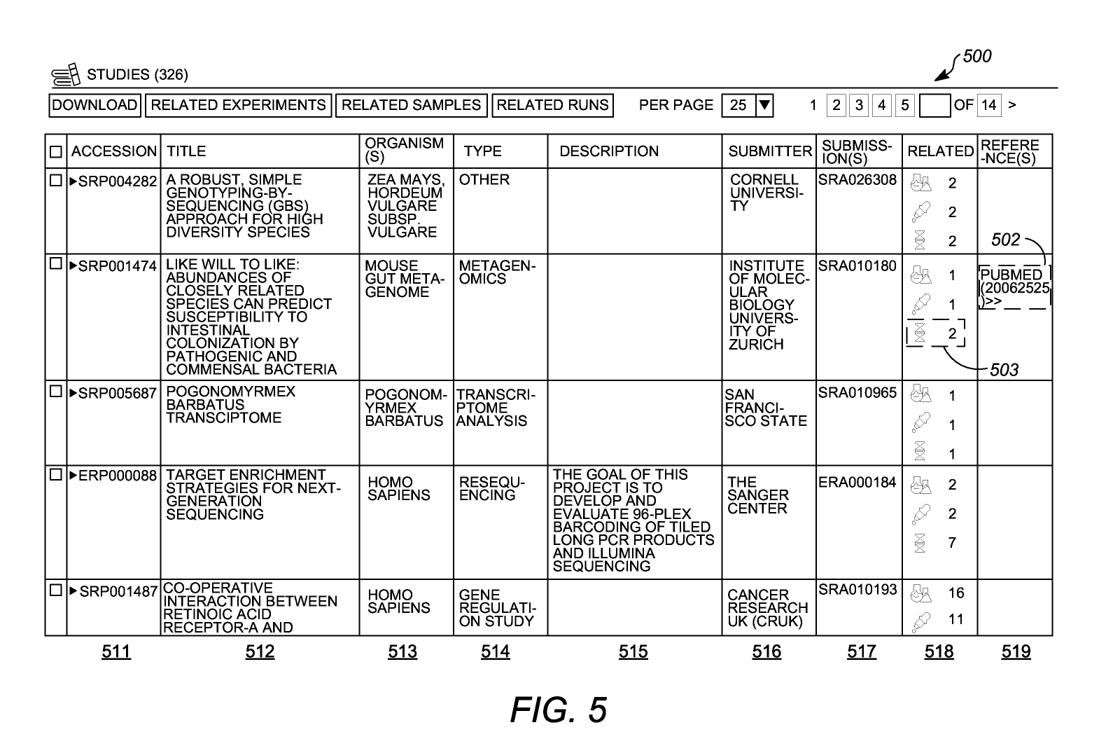

FIG. 5 depicts an exemplary search results table 500. In one embodiment, search result table 500 may be search results table 303 from search results screen 300 (FIG. 3). Search results table 500 may include one or more columns for displaying information related to studies. For example, search results table 500 may include column 511 for displaying accession IDs, column 517 for displaying submission IDs that each corresponds to the submission ID of a research paper, column 518 for displaying counts of related objects (e.g., studies, samples, and/or runs), and column 519 for displaying reference information, such as links to related published pubmed articles.

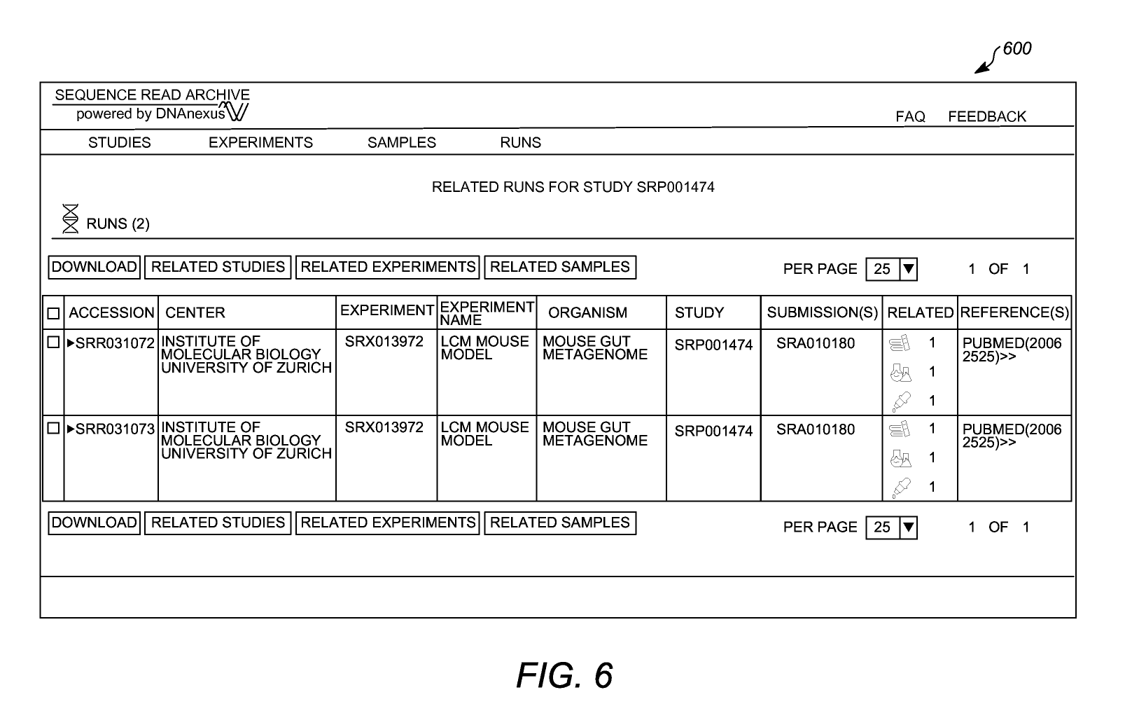

A user may navigate to a pubmed article that describes a study by clicking on a corresponding link in column 519. For example, a user may access pubmed article “20062525” by clicking on link 502. Further, column 518 of search results table 500 may display, for each study, a number of objects related to the study (e.g., counts of experiments, samples, and/or runs). A user may click on the displayed numbers to retrieve the related objects. For example, a user may click on icon 503 to retrieve the two runs that are related to study “SRP001474.” FIG. 6 depicts an exemplary related runs screen 600 that SRA system 100 may present to the user after the user clicks icon 503 (FIG. 5). Related runs screen 600 illustrates the two runs that are related to study “SRP001474.”

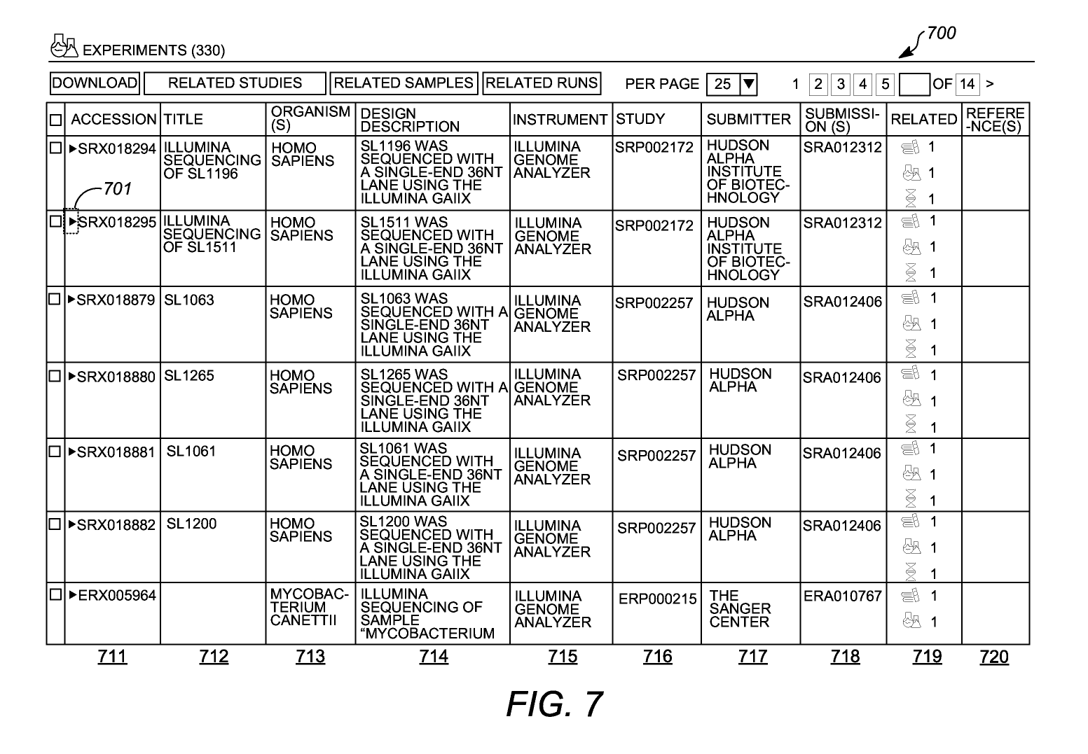

FIG. 7 depicts an exemplary search results table 700. In one embodiment, search results table 700 may be search results table 403 from search results screen 400 (FIG. 4). Search results table 700 may include one or more columns for displaying information related to experiments. For example, search results table 700 may include column 711 for displaying accession IDs, column 718 for displaying submission IDs that each corresponds to the submission ID of a research paper, column 719 for displaying counts of related objects (e.g., studies, samples, and/or runs), and column 720 for displaying reference information, such as links to related published pubmed articles.

Column 711 includes expander icon 701 for causing additional information about each displayed experiment to be displayed in search results table 700. When a user clicks on expander icon 701, which is associated with experiment “SRX018295,” additional information related to experiment “SRX018295” is displayed in an inline view directly below the search result row for experiment “SRX018295.”

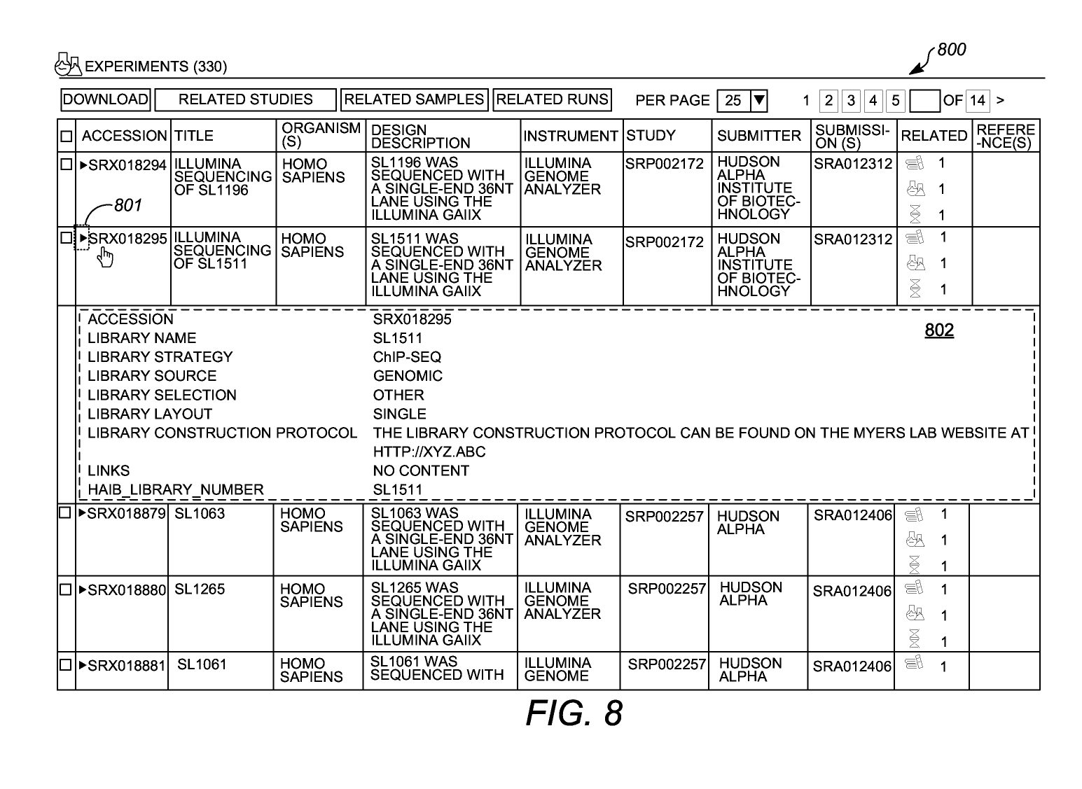

FIG. 8 depicts an exemplary search results table 800 that SRA system 100 may present to the user after the user clicks on expander icon 701 (FIG. 7). As shown in FIG. 8, expander icon 801 is in the expanded position, and search results table 700 remains displayed while additional information related to experiment “SRX018295” is provided in inline view 802. In other words, a user need not navigate to another web page or to a pop-up window in order to view the additional information related to experiment “SRX018295.” Instead, the rows of search results below experiment “SRX018295” may be shifted downwards in search results table 800 such that inline view 802 may be displayed within search results table 800.

The information displayed in an inline view may be specific to the type of object for which the inline view is being displayed. As shown in FIG. 8, inline view 802 may display certain additional information for experiment objects such as experiment “SRX018295.” However, the inline view for other objects (e.g., studies, samples, and/or runs) may be different from inline view 802 for experiment objects (FIG. 8). Further, multiple inline views that each corresponds to a different row in a search results table may be displayed simultaneously.

In some embodiments, inline view 802 may display additional information that is not otherwise displayed by search results table 800 outside of inline view 802. In some embodiments, inline view 802 may exclude information that is already displayed by search results table 800 outside of inline view 802. In some embodiments, inline view 802 may repeat information that is already displayed by search results table 800 outside of inline view 802. In some embodiments, inline view 802 may be accessible by a direct uniform resource locator (URL), meaning that SRA system 100 may present the information contained in inline view 802 to a user via a standalone web page, and the standalone web page may be presented to a user in response to the user's navigation to a specific URL.

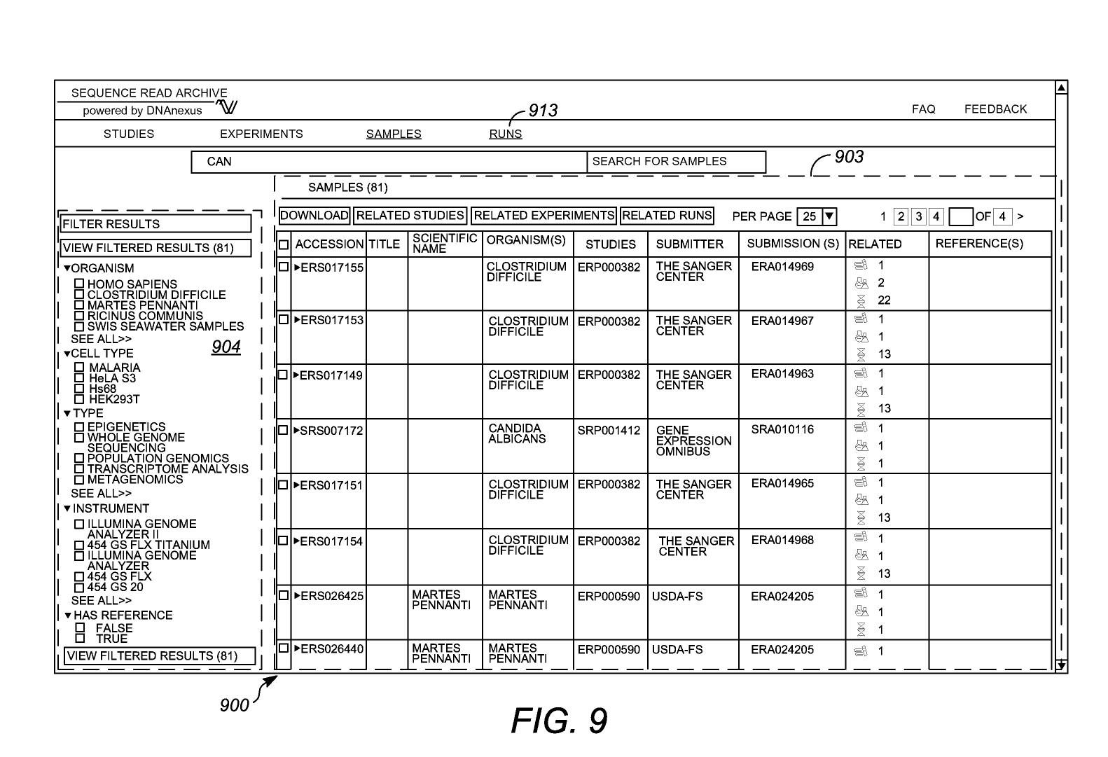

FIG. 9 depicts an exemplary search results screen 900 that SRA system 100 may present to the user after the user clicks on tab 412 (FIG. 4). As shown in FIG. 9, search results screen 900 may display, among others, inline views, related information, and reference information related to samples. Search results screen 900 may also include filter dialog 904 for filtering samples that are included in search results table 903.

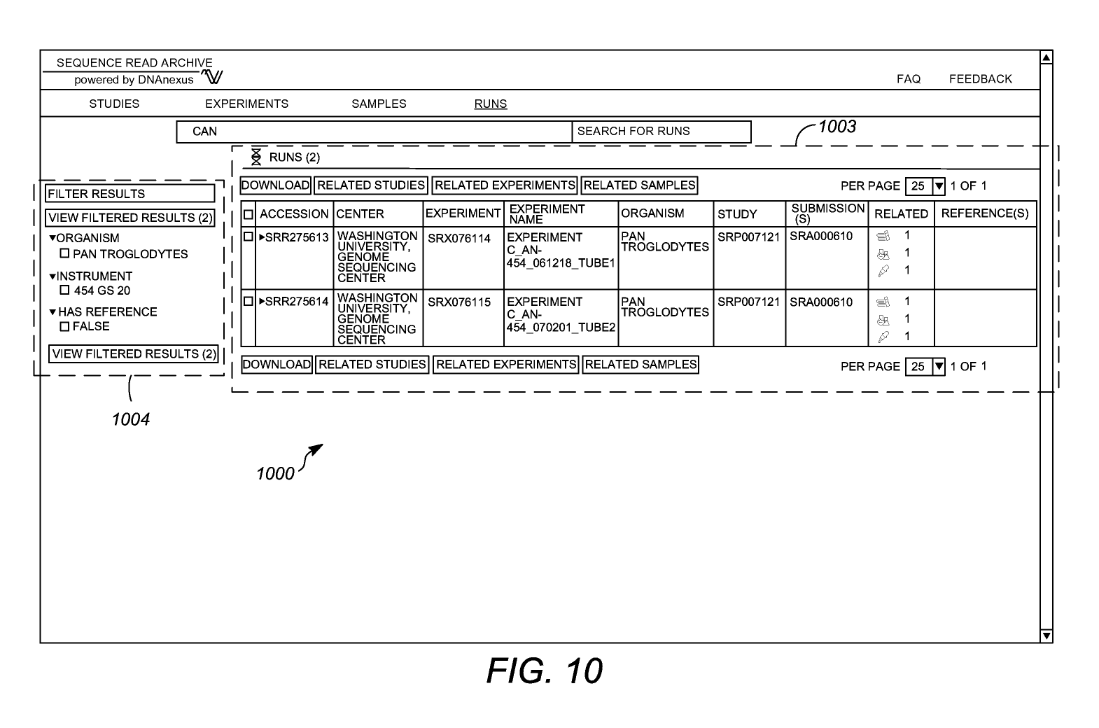

FIG. 10 depicts an exemplary search results screen 1000 that SRA system 100 may present to the user after the user clicks on tab 913 (FIG. 9). As shown in FIG. 10, search results screen 1000 may also include the ability to display, among others, inline views, related information, and reference information related to runs. Search results screen 1000 may also include filter dialog 1004 for filtering runs that are included in search results table 1003.

### Filter Dialog

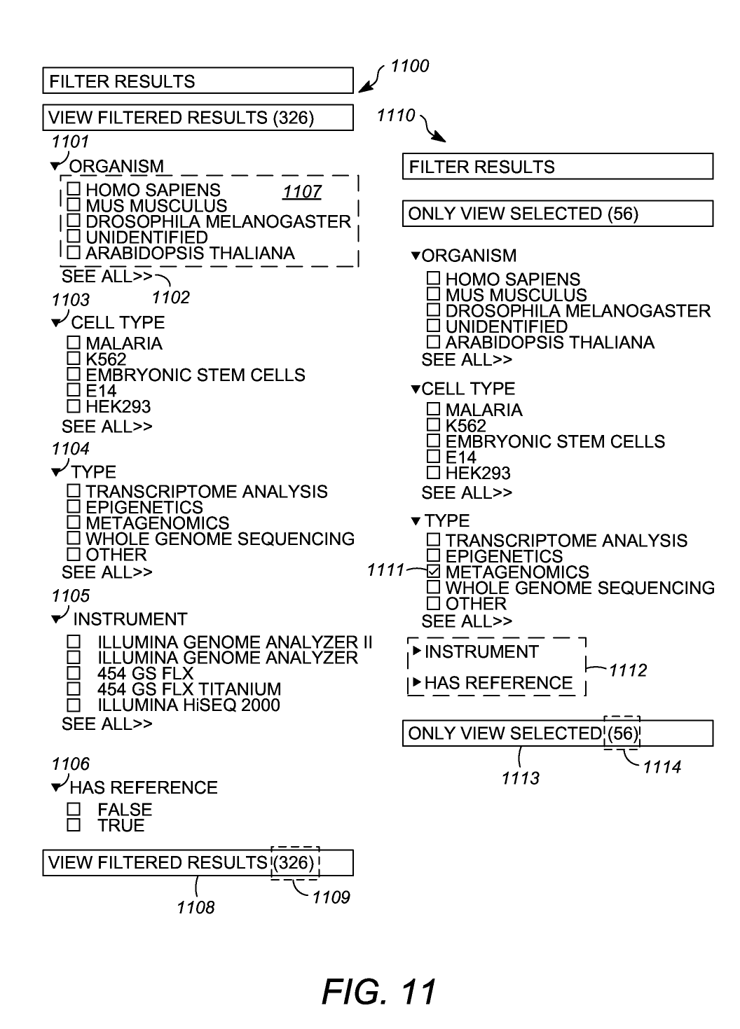

As discussed above, each of the search result screens depicted in FIG. 3 (studies), FIG. 4 (experiments), FIG. 9 (samples), and FIG. 10 (runs) may include a filter dialog. FIG. 11 depicts exemplary filter dialog 1100 that may be used to control the display of objects in a corresponding search results table. In one embodiment, filter dialog 1100 may represent filter dialog 304 on search results screen 300 for studies (FIG. 3). As shown in FIG. 11, filter dialog 1100 may include a list of filter controls 1101-1106. Filter controls 1101-1106 may be used to prevent certain search results from being displayed.

Each filter control in filter dialog 1100 may be associated with a search results table column. For example, organism filter control 1101 may be associated with a search results table column labeled organism (FIG. 3). Also, a filter control may be associated with filter values. For example, organism filter control 1101 may be associated with filter control values 1107.

Counter 1109 may be embedded into button to indicate the number of search results meeting the current selection of filter control values. The value of counter 1109 may change as a user selects or unselects filter control values in filter dialog 1100. For example, in response to a user's selection of filter control value 1111 (i.e., metagenomics), SRA system 100 may update counter 1114 to indicate that 56 studies (out of the 326 studies in the original search results) have a value of “metagenomics” for the “Type” column of the search results table. As such, counter 1114 provides a preview of the effects of a particular filter control value selection.

Further, the label of button 1113 may change in response to the user's selection of filter control values. For example, when filter value 1111 is selected, button 1108 may be relabeled to become button 1113. When button 1113 is clicked, SRA system 100 may update search results table 303 to include only the 51 studies that have a value of “metagenomics” in the “Type” column of the search results table.

In some embodiments, the set of filter controls included in filter dialog 1100 may be determined based on the search result objects (e.g., studies, experiments, samples, runs) being filtered. The availability of filter controls for each search result object may be configured via a user or system administration tool. As a non-limiting example, Table 1 lists, for each object, search results table columns that may be configured to have corresponding filter controls.

TABLE 1

| | Studies | Experiments | Samples | Runs |
|---|---|---|---|---|
| Organism | X | X | X | X |
| Cell Type | X | X | X | X |
| Type | X | X | X | X |
| Submitter | X | X | X | X |
| Instrument | X | X | X | X |
| Has reference | X | X | X | X |
| Library strategty | | X | | |
| Library source | | X | | |
| Library selection | | X | | |
| Sex | | | X | |

In some embodiments, the filter controls included in filter dialog 1100 may be content driven, meaning that the inclusion of a filter control into filter dialog 1100 may be determined by the availability of search result information related to the filter control. For example, it may be possible to configure search results table 303 (via a user or system administration tool) such that the category of “Submitter” is not displayed. When the “Submitter” category of information is not displayed in search results table 303, SRA system 100 may exclude the corresponding “Submitter” filter control from filter dialog 1100. Search result information that are configured for display in the inline view of a search results table may be considered to be displayed for purposes of displaying filter controls in filter dialog 1100. In other words, filter dialog 1100 may include filter controls associated with search result information that are to be displayed in the inline view.

As another example, filter dialog 1100 may exclude filter controls associated with empty columns in a search results table. For example, if none of the studies in search results table 303 contain a value for the category of “Cell Type,” SRA system 100 may exclude the “Cell Type” filter control from the filter dialog corresponding to search results table 303. SRA system 100 may also hide the “Cell Type” column from view in search results table 303.

A filter control may be displayed in an expanded view or a non-expanded view. An expander icon may be used to control the expansion of a filter control. In the non-expanded view, filter control values associated with a filter control are hidden from view. FIG. 11 illustrates filter controls 1111 and 1112 in the non-expanded view. In the expanded view, filter control values associated with a filter control are displayed in the filter dialog. FIG. 11 illustrates filter controls 1101-1106 in the expanded view.

In some embodiments, the filter controls values displayed with a filter control may be content driven, meaning that the inclusion of a filter control value into, for example, list 1107 may be determined by the availability of search result information related to the filter control value. For example, organism filter control 1101, which is in the expanded view, includes list 1107 of top filter control values and link 1102 labeled “see all.” As used here, top filter control values refers to filter control values that are most frequently included in the search results table corresponding to filter dialog 1100. As shown in FIG. 11, in the expanded view of organism filter control 1101, a list 1107 of five top filter control values are displayed. The top filter control values displayed in list 1107 may change in response to different searches being performed. List 1107 may be ordered by frequency, meaning that the filter control value of highest frequency for a particular search results table (e.g., homo sapiens) may be displayed at the top of list 1107.

As discussed above, a search results table may include a number of search results (e.g., 326 search results) but display only a subset of the search results (e.g., a page of 25 rows) at a time. In some embodiments, the top filter control values in list 1107 may be selected based on an entire search results table regardless of whether the filter control values are being displayed on a current page of search results. In some embodiments, the top filter control values in list 1107 may be selected from a currently displayed page of search results of the search results table.

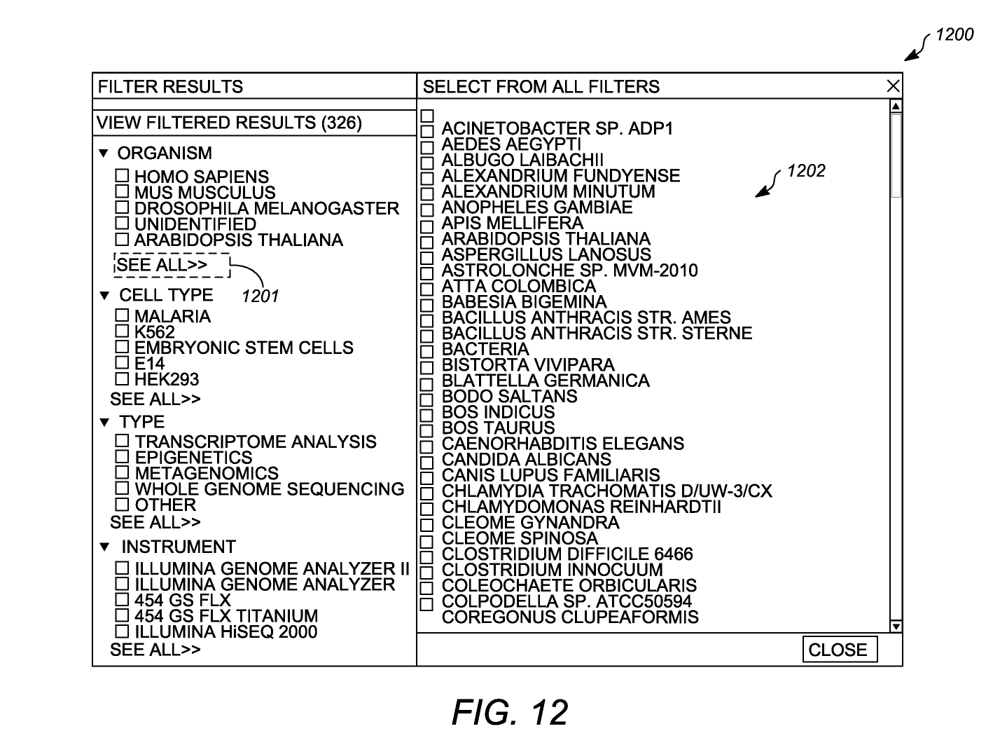

A filter control may have more than five filter control values and SRA system 100 may provide an additional window to display additional filter control values to a user. For example, a user may click “see all” link 1102 to display the remaining filter control values that are associated with organism filter control 1101. FIG. 12 illustrates filter control value selection window 1202 that is displayed adjacent to filter dialog 1200 when a user clicks on “see all” link 1102. Filter control value selection window 1202 includes a list of filter control values that may be used to control the display of search results in a search results table. In some embodiments, the list of filter control values displayed in filter control value selection window 1202 may be based on the current search results. Specifically, each displayed filter control value may be associated with at least one of the current search results.

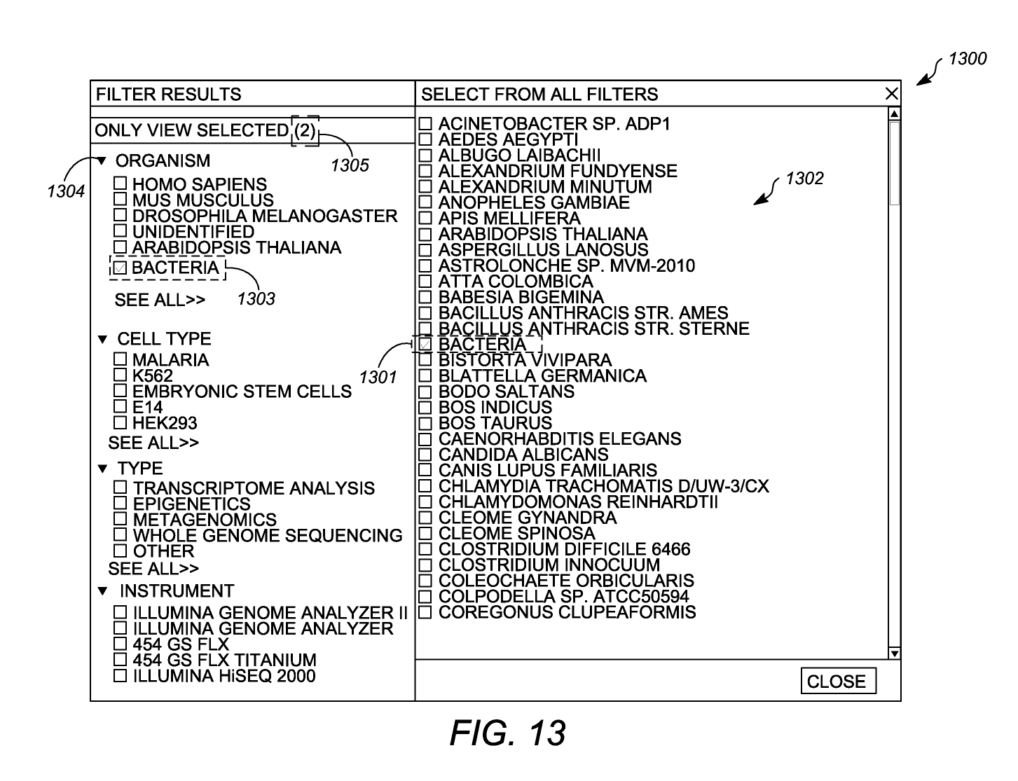

Turning to FIG. 13, when filter control value 1301 (bacteria) is selected from filter value selection window 1302, a corresponding display 1303 for the filter control value is added to the list of filter control values for organism filter control 1304 in filter dialog 1300. Further, counter 1305 is updated to indicate the number of search results that meet the current selection of filter control values.

### Download of SRA Information

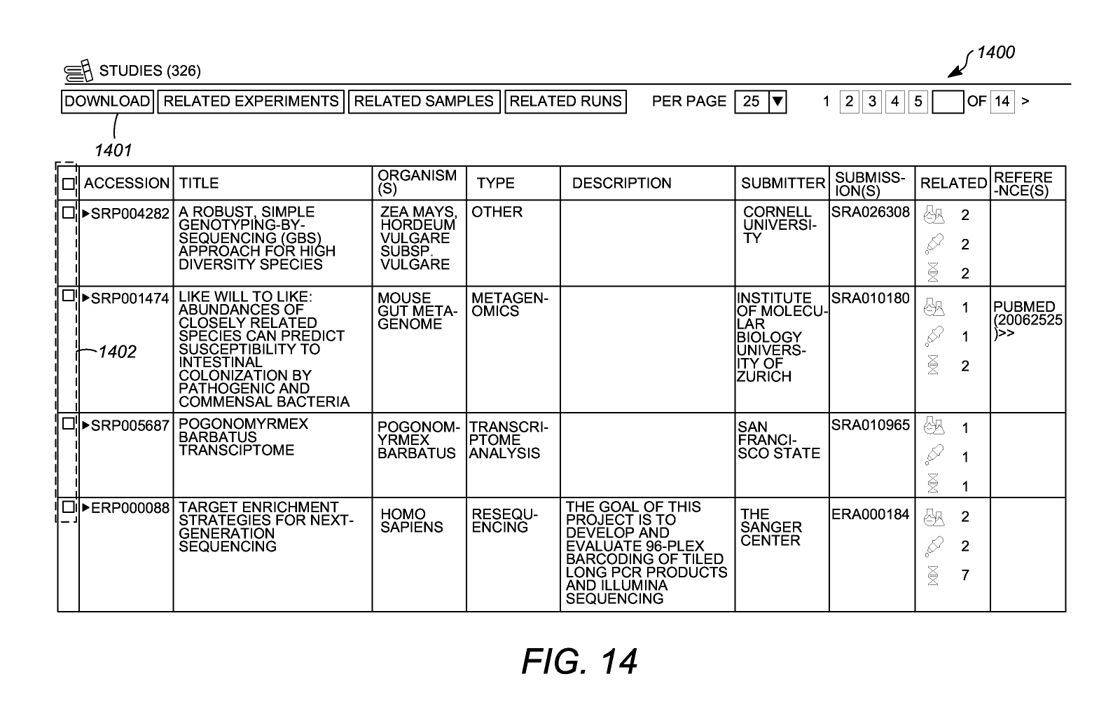

Each of the search result screens depicted in FIG. 3 (studies), FIG. 4 (experiments), FIG. 9 (samples), and FIG. 10 (runs) may also include sequence data download capabilities. FIG. 14 depicts exemplary search results table 1400. In one embodiment, search results table 1400 may be search results table 303 of search results page 300 (FIG. 3). FIG. 14 illustrates download button 1401 and table row checkboxes 1402. A user may select one or more rows (e.g., studies) of search results table 1400 via table row checkboxes 1402 and click download button 1401 to select sequence data corresponding to the selected studies for download.

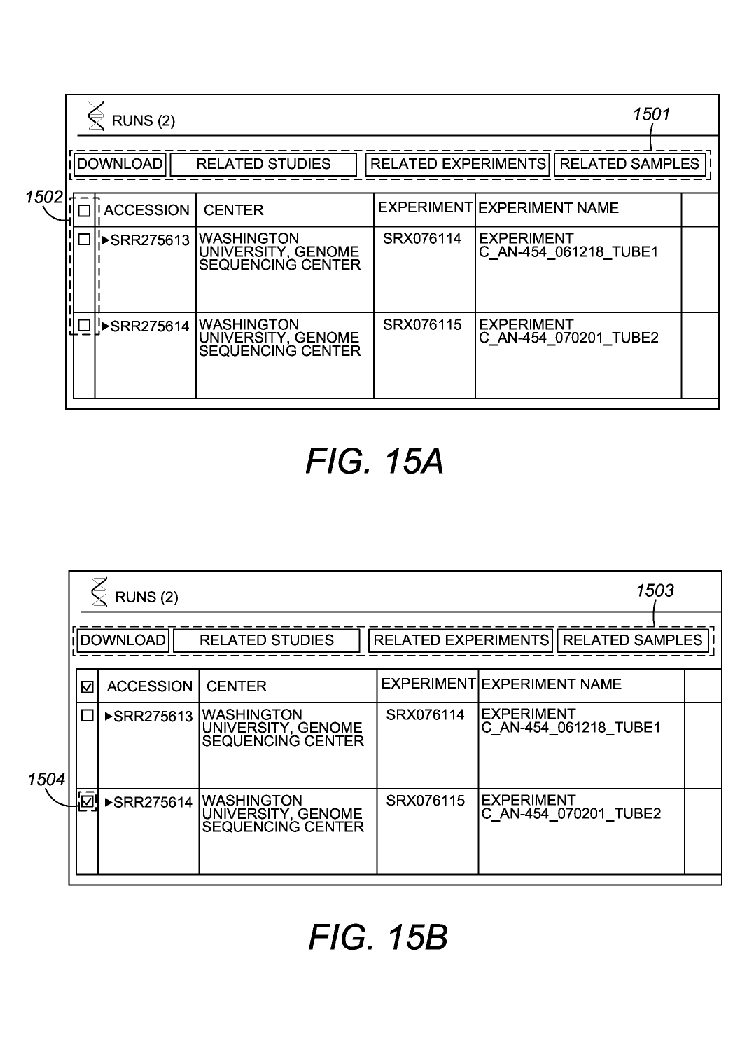

In some embodiments, download button 1401 may be disabled until at least one row of search results table 1400 is selected by a user. As shown in FIG. 15A, buttons 1501 (including the download button) are disabled because checkboxes 1502 are unchecked. As shown in FIG. 15B, buttons 1503 (including the download button) are enabled because checkbox 1504 is checked.

It should be noted that while sequence data may be associated with runs directly, sequence data may not be associated with studies, experiments, and/or samples directly. That is, the association of a set of sequence data with studies, experiments, and/or samples may depend on the relationship between a run and a study, experiment, and/or sample. As such, when a user clicks on the download button from the search result screens for studies, experiments, and samples, SRA system 100 may first determine the underlying runs that may be associated with selected objects (e.g., studies, experiments, or samples) indirectly, in order to determine the corresponding sequence data that may be available for download by the user.

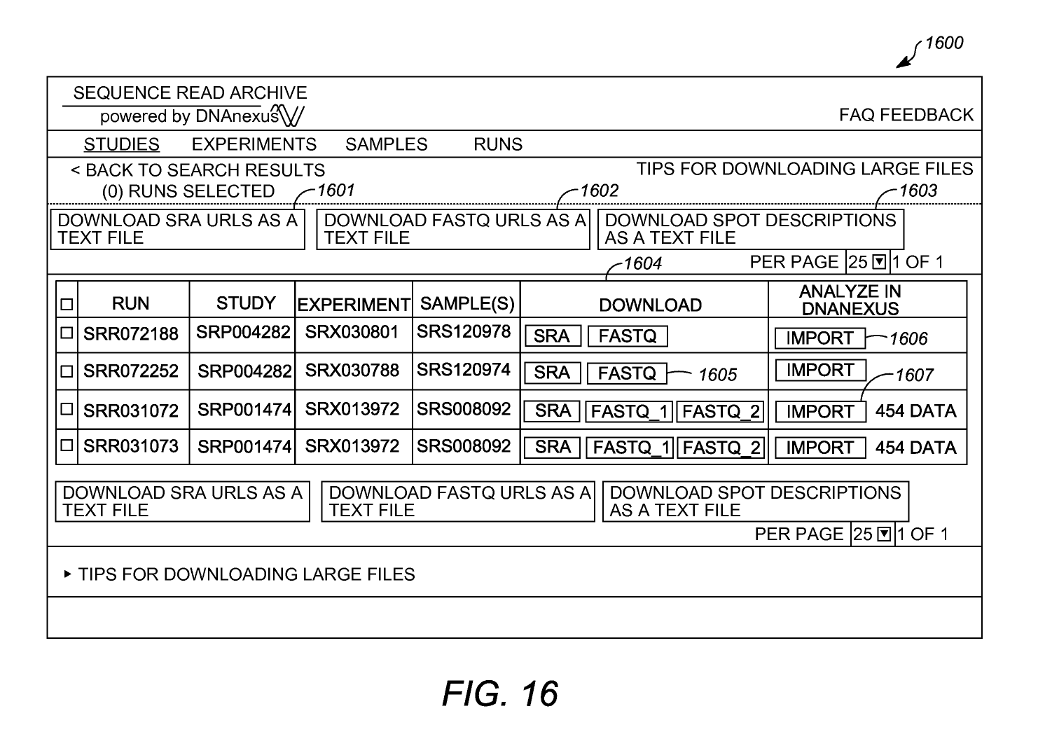

In some embodiments, SRA system 100 may present an intermediate download page to the user to confirm the sequence data that SRA system 100 may have determined to be related (directly and/or indirectly) to the selected objects. FIG. 16 depicts an exemplary intermediate download page that may be displayed when sequence data associated with multiple studies are selected for download from a search results table, such as search results table 303 of FIG. 3.

As shown in FIG. 16, table 1600 may include download buttons 1601-1603 for initiating the download of sequence information. For example, buttons 1601 and 1602 may initiate the download of SRA URLs and FASTQ URLs as a text file, respectively, for one or more runs in table 1600 that are selected. Similarly, button 1603 may initiate the downloading of spot descriptions as a text file for one or more runs in table 1600 that are selected. For example, a user may click on the checkboxes in the left-most column of table 1600 to select one or more rows of table 1600, and the user may click on any one of buttons 1601-1603 to download information associated with the selected rows of runs. Table 1600 may also include download buttons in table column 1604. Button 1605 may initiate the download of FASTQ URL(s) as a text file for a single run. That is, a user may click on button 1604 to download the FASTQ URL(s) associated with run “SRR72252.”

Further, as shown in column 1604, multiple FASTQ download buttons (e.g., FASTQ_1 and FASTQ_2) may each provide for the downloading of a FASTQ URL(s) of the left or the right sequence reads that are associated with a run. In comparison, buttons 1602 and 1605 may download all available FASTQ URLs (left and/or right sequence reads) that are associated with the corresponding (e.g., selected) runs. Further, in some embodiments, table 1600 may include button 1606 for performing additional analysis of specific sequence data. Button 1604 may redirect the user to a web site to be named DNAnexus for analyzing sequence data. Button 1607 may be shown in a disabled state if additional analysis of a specific sequence data may not be performed. It should be noted that the display of buttons 1601-1603 and 1605-1607 may vary between different embodiments of SRA system 100.

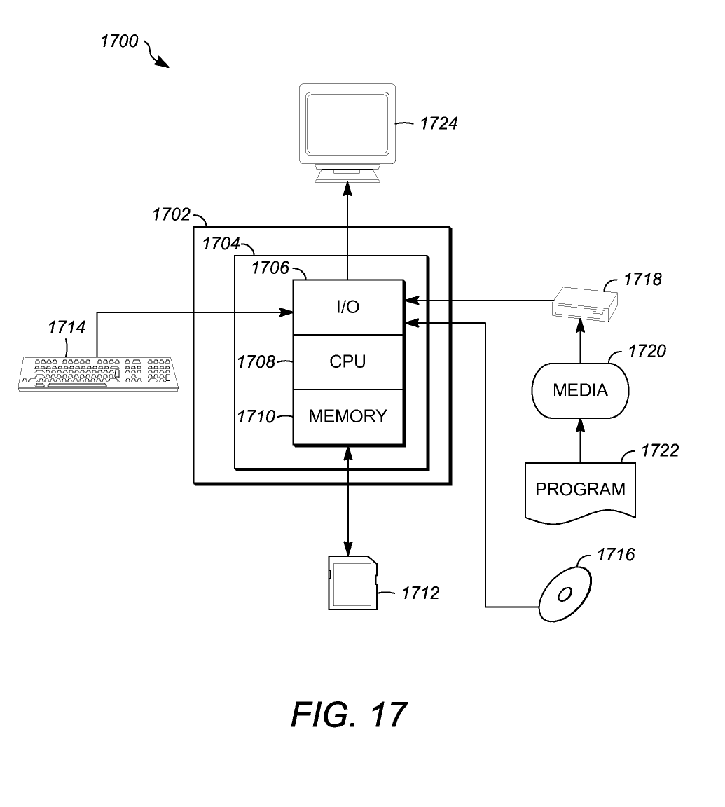

FIG. 17 depicts computing system 1700 with a number of components that may be used to perform the above-described processes. The main system 1702 includes a motherboard 1704 having an I/O section 1706, one or more central processing units (CPU) 1708, and a memory section 1710, which may have a flash memory card 1712 related to it. The I/O section 1706 is connected to a display 1724, a keyboard 1714, a disk storage unit 1716, and a media drive unit 1718. The media drive unit 1718 can readwrite a computer-readable medium 1720, which can contain programs 1722 and/or data.

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Although only certain exemplary embodiments have been described in detail above, those skilled in the art will readily appreciate that many modifications are possible in the exemplary embodiments without materially departing from the novel teachings and advantages of this disclosure. For example, aspects of embodiments disclosed above can be combined in other combinations to form additional embodiments. Accordingly, all such modifications are intended to be included within the scope of this technology.

1. A computer-implemented method for processing stored short and long sequence reads, the method comprising:
receiving, from a user, a search term and a search category, wherein the category is selected from the group consisting of a study, an experiment, a sample and a run;
determining search results based on the search term, wherein the search results belong to the search category;
displaying at least a subset of the search results;
receiving, from the user, a selection of one or more of the displayed search results; and
determining a relationship between the selected search results and one or more runs, wherein a run of the one or more runs is associated with DNA sequence information, and the run is determined based on association between the selected results and an experiment, an association between the selected results and a sample, or an association between the selected results and a run, and
displaying at least a portion of the determined relationship.

2. The method of claim 1, further comprising:
displaying a set of filter controls;
receiving, from the user, a selection of a filter control of the set of filter controls;
determining filtered search results based on the user's selection of the filter control, wherein the filtered search results includes a subset of the search results;
displaying a numerical count of the filtered search results without displaying the filtered search results, wherein the numerical count is embedded into a button for causing the display of the filtered search results; and
displaying the filtered search results only after the user selects the button.

3. The method of claim 1, further comprising:
identifying and displaying sequence data associated with the determined one or more runs, wherein:
the displaying of sequence data includes a display of an associated study, an associated experiment, and an associated sample; and
transmitting, to a user device, a uniform resource locator for accessing the identified sequence information, wherein the identified sequence information is to be provided in FASTQ or SRA format.

4. The method of claim 1, wherein the displaying of the subset of search results comprises:
displaying a first plurality of categories of information as vertical columns in a table;
displaying an expander icon, wherein the expander icon is associated with a row of the table;
receiving, from the user, a selection the expander icon; and
in response to the received selection, displaying a second plurality of categories of information in between two consecutive rows of the table while at least a portion of the previously displayed content remains displayed, wherein the second plurality of categories of information are associated with the expanded row of the table.

5. The method of claim 1, further comprising:
displaying a search button wherein the search button has a color indicative of the search category; and
displaying a submission identification wherein the submission identification is associated with the submission of a published article in the scientific community.

6. A system for processing DNA sequence information, the system comprising:
a database of DNA sequence data;
a server connected to the database and configured to:
receive, from a user, a search term and a search category, wherein the category is selected from the group consisting of a study, an experiment, a sample and a run;
determine search results based on the search term, wherein the search results belong to the search category;
cause the display of at least a subset of the search results;
receive, from the user, a selection of one or more of the displayed search results; and
determine a relationship between the selected search results and one or more runs, wherein a run of the one or more runs is associated with DNA sequence information, and the run is determined based on association between the selected results and an experiment, an association between the selected results and a sample, or an association between the selected results and a run, and
cause the display of at least a portion of the determined relationship.

7. The system of claim 6, wherein the server is further configured to:
cause the display of a set of filter controls.
receive, from the user, a selection of a filter control of the set of filter controls;
determine filtered search results based on the selection of the filter control, wherein the filtered search results includes a subset of the search results;
cause the display of a numerical count of the filtered search results without causing a display of the filtered search results, wherein the numerical count is embedded into a button for causing the display of the filtered search results; and
cause the display of the filtered search results only after the user selects the button.

8. The system of claim 6, wherein the server is further configured to:
identify sequence data associated with the determined one or more runs;
cause the display of the sequence data, wherein the caused display includes the display of an associated study, an associated experiment, and an associated sample; and
transmit, to a user computing device, a uniform resource locator for accessing the identified sequence information, wherein the identified sequence information is to be provided in FASTQ or SRA format.

9. The system of claim 6, wherein the server is further configured to:
cause the display of a first plurality of categories of information as vertical columns in a table;
cause the display of an expander icon, wherein the expander icon is associated with a row of the table;
receive from the user a selection of the expander icon; and
in response to the selection, cause the display of a second plurality of categories of information in between two consecutive rows of the table while at least a portion of the previously displayed content remains displayed, wherein the second plurality of categories of information are associated with the expanded row of the table.

10. The system of claim 6, wherein the server is further configured to:
cause the display of a search button wherein the search button has a color indicative of the search category; and
cause the display of a submission identification wherein the submission identification is associated with the submission of a published article in the scientific community.

11. A non-transitory computer-readable storage medium having computer-executable instructions for obtaining DNA sequence information, comprising instructions for:
receiving, from a user, a search term and a search category, wherein the category is selected from the group consisting of a study, an experiment, a sample and a run;
determining search results based on the search term, wherein the search results belong to the search category;
displaying at least a subset of the search results;
receiving, from the user, a selection of one or more of the displayed search results; and
determining a relationship between the selected search results and one or more runs, wherein the runs are associated with DNA sequence information, and the runs are determined based on association between the selected results and an experiment, association between the selected results and a sample, or association between the selected results and a run, and
displaying at least a portion of the determined relationship.

12. The computer-readable storage medium of claim 11, further comprising instructions for:
displaying a set of filter controls;
receiving, from the user, a selection of a filter control of the set of filter controls;
determining filtered search results based on the user's selection of the filter control, wherein the filtered search results includes a subset of the search results;
displaying a numerical count of the filtered search results without displaying the filtered search results, wherein the numerical count is embedded into a button for causing the display of the filtered search results; and
displaying the filtered search results only after the user selects the button.

13. The computer-readable storage medium of claim 11, further comprising instructions for:
identifying and displaying sequence data associated with the determined one or more runs, wherein:
the displaying of sequence data includes a display of an associated study, an associated experiment, and an associated sample; and
transmitting, to a user device, a uniform resource locator for accessing the identified sequence information, wherein the identified sequence information is to be provided in FASTQ or SRA format.

14. The computer-readable storage medium of claim 11, further comprising instructions for:
displaying a first plurality of categories of information as vertical columns in a table;
displaying an expander icon, wherein the expander icon is associated with a row of the table;
receiving, from the user, a selection the expander icon; and
in response to the received selection, displaying a second plurality of categories of information in between two consecutive rows of the table while at least a portion of the previously displayed content remains displayed, wherein the second plurality of categories of information are associated with the expanded row of the table.

15. The computer-readable storage medium of claim 11, further comprising instructions for:
displaying a search button wherein the search button has a color indicative of the search category; and
displaying a submission identification wherein the submission identification is associated with the submission of a published article in the scientific community.
